(19) United States
(12) Patent Application Publication
(10) Pub. No.: US 2007/0206508 A1
(43) Pub. Date: Sep. 6, 2007

(54) METHODS AND APPARATUS FOR SUPPORTING FRAGMENTATION AND DEFRAGMENTATION IN A WLAN

(75) Inventors: Mohammed Sammour, Montreal (CA); Sudheer A. Grandhi, Mamaroneck, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/566,533

(22) Filed: Dec. 4, 2006

Related U.S. Application Data
(60) Provisional application No. 60/748,079, filed on Dec. 7, 2005.

(51) Int. Cl. H04J 1/16

(52) U.S. Cl. 370/252

(57) ABSTRACT

High throughput (HT) devices are required to support defragmentation for reassembling a medium access control (MAC) service data unit (MSDU) or a MAC protocol data unit (MPDU) from its fragments, but may or may not fragment data to be transmitted. In one embodiment, a wireless transmit/receive unit (WTRU) includes a data defragmentation unit which defragments any fragmented data received by the WTRU, but the WTRU does not transmit fragmented data. In another embodiment, a WTRU includes a processor, a data fragmentation unit, a transmitter and a fragmentation selection unit. The processor determines whether or not the transmitter should transmit fragmented data. When fragmentation is desired, the processor controls the fragmentation selection unit such that the data fragmentation unit fragments data provided by the processor for transmission by the transmitter.

### CROSS REFERENCE TO RELATED APPLICATION

This application claims the benefit of U.S. Provisional Application No. 60/748,079 filed Dec. 7, 2005, which is incorporated by reference as if fully set forth.

### FIELD OF INVENTION

The present invention is related to a wireless local area network (WLAN), such as an IEEE 802.11-based WLAN. More particularly, the present invention is related to the support of fragmentation and defragmentation in a WLAN.

### BACKGROUND

Advanced WLANs are currently being considered by the IEEE standards community. The IEEE 802.11n standard promises to provide higher data throughputs than its predecessors by supporting new physical layer (PHY) and medium access control (MAC) features.

One new MAC feature enhancement being proposed includes MAC service data unit (MSDU) aggregation, where two or more MSDUs may be aggregated into a single aggregated-MSDU (A-MSDU). Similarly, MAC protocol data unit (MPDU) aggregation may be implemented, where two or more MPDUs may be aggregated into a single aggregated MPDU (A-MPDU). This MAC feature enhancement may improve system efficiency, (e.g., system throughput).

Another new MAC feature enhancement being proposed includes a block acknowledgment (ACK) (BA) enhancement. A BA acknowledges that a block of packets or a window of packets has been received, rather than only acknowledging one packet at a time, which provides efficiency in terms of throughput. A recipient is the intended receiver of the packets sent by a transmitter. The transmitter and receiver addresses are typically included in the MAC header of each packet.

One BA enhancement is a partial BA recipient state feature, where the recipient's receiver station utilizes the same memory of a BA record to collect data from different originators, and where such record is reset if the recipient receives a transmission from a different originator. The BA recipient partial state feature reduces the amount/cost of the memory required to maintain full BA recipient state. With partial BA, the same memory is used for all transmitters except that the partial BA information is sent to the corresponding transmitter as soon as new transmitter packets are received, because the memory will now be used for the BA of the new transmitter packets. Alternatively, partial state information may simply overwrite the memory without sending the partial state information to the corresponding transmitter.

The full BA state will maintain a BA record for each transmitter. The memory size requirements are based on the number of transmitters.

When the MDSU size is large, a fragmentation feature may be used, such that the MDSU may be fragmented into smaller packets and sent as several MPDUs to increase robustness of transmission.

Another BA enhancement being proposed uses no fragmentation in BA. In order to reduce the amount of memory required to maintain the BA state, high-throughput (HT) devices must utilize a compressed BA format when they negotiate BA agreements, without using the fragmentation feature. This reduces the BA state memory required by a factor of 16, since fragmentation may result in up to 16 fragments per MSDU.

Yet another BA enhancement uses an implicit BA request (BAR), which is sent by the transmitter to solicit a BA response from a recipient's receiver. Instead of sending an explicit BAR frame, an implicit BA request is achieved by asserting a “normal ACK” within the “ACK policy” field of MPDU headers within an A-MPDU aggregate. Currently, it is only for an A-MPDU aggregate that implicit BAR is supported. Thus, implicit BAR is not supported for a single MPDU.

Although fragmentation is not permitted when HT devices negotiate BA agreements among themselves, the above proposals do not describe if and how fragmentation will be supported under other scenarios, such as when using a normal ACK instead of a BA.

There are several issues related to the interaction between the fragmentation features and the other proposed IEEE 802.11 in features. One challenge is to provide some operational modes in which support for fragmentation or defragmentation is provided by an HT device. It is also desirable to determine solutions to some of the problems related to the BA and A-MPDU features when fragmentation is used.

### SUMMARY

The present invention is related to HT devices which are required to support defragmentation for reassembling an MSDU or an MPDU from its fragments, but may or may not fragment data to be transmitted. In one embodiment, a wireless transmit/receive unit (WTRU) includes a data defragmentation unit which defragments any fragmented data received by the WTRU, but the WTRU does not transmit fragmented data. In another embodiment, a WTRU includes a processor, a data fragmentation unit, a transmitter and a fragmentation selection unit. The processor determines whether or not the transmitter should transmit fragmented data. When fragmentation is desired, the processor controls the fragmentation selection unit such that the data fragmentation unit fragments data provided by the processor for transmission by the transmitter.

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 is a block diagram of a wireless transmit/receive unit (WTRU) configured without a fragmentation capability in accordance with one embodiment of the present invention; and

FIG. 2 is a block diagram of a wireless transmit/receive unit (WTRU) configured with a selectable fragmentation capability in accordance with another embodiment of the present invention.

### DETAILED DESCRIPTION OF THE PREFERRED EMBODIMENTS

When referred to hereafter, the terminology “wireless transmit/receive unit (WTRU)” includes but is not limited to a user equipment (UE), an HT device, a mobile station, a fixed or mobile subscriber unit, a pager, a cellular telephone, a personal digital assistant (PDA), a computer, or any other type of user device capable of operating in a wireless environment.

When referred to hereafter, the terminology “access point (AP)” includes but is not limited to a base station, a Node-B, a site controller, or any other type of interfacing device capable of operating in a wireless environment.

The features of the present invention may be incorporated into an integrated circuit (IC) or be configured in a circuit comprising a multitude of interconnecting components.

The present invention determines when fragmentation features are to be supported in conjunction with other MAC mechanisms, such as the aggregation of MPDUs. In accordance with the present invention, HT devices, (i.e., WTRUs), are required to support defragmentation, (i.e., reassembling an MSDU from its fragment), but are not required to support fragmentation. This feature relieves HT devices from the implementation complexity and performance issues that can arise from fragmentation, while enabling backward compatibility with previous standards of WLAN devices, such as IEEE 802.11a/b/g or IEEE 802.11e. Such an HT device transmits data while not using fragmentation, but is able to defragment any received fragmented data from a legacy or previous generation device.

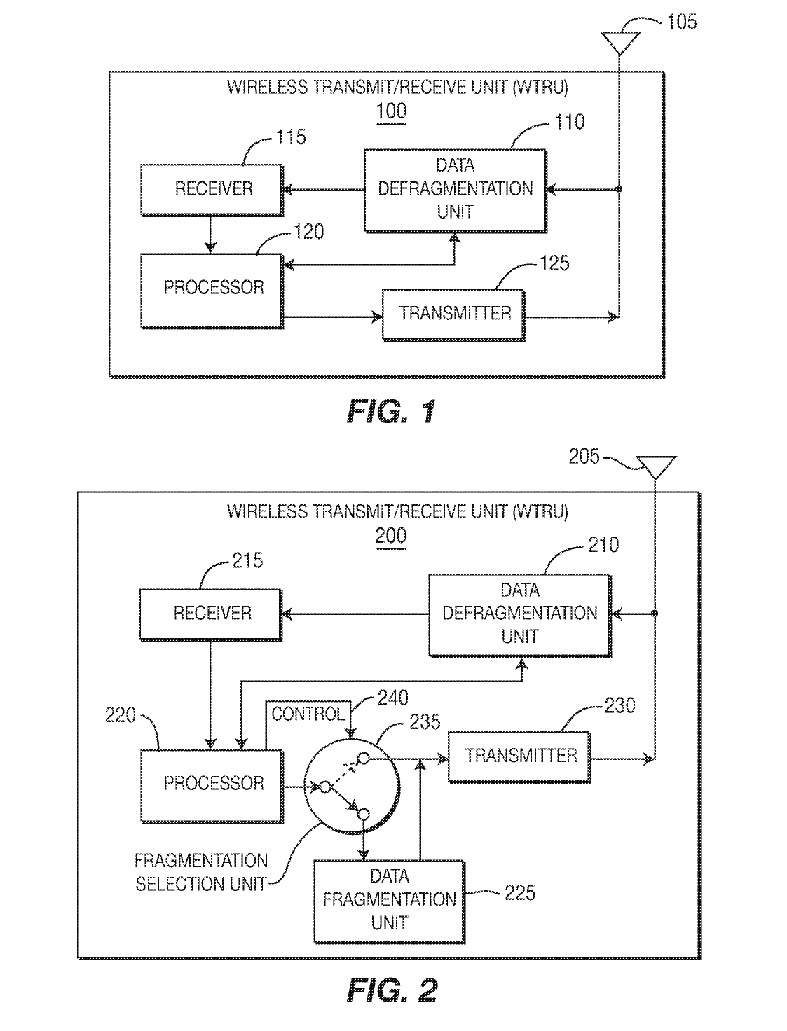

FIG. 1 is a block diagram of a WTRU 100 configured without a fragmentation capability in accordance with one embodiment of the present invention. The WTRU 100 includes an antenna 105, a data defragmentation unit 110, a receiver 115, a processor 120 and a transmitter 125. The transmitter 125 of the WTRU 100 transmits data while not using fragmentation, but the data defragmentation unit of the WTRU defragments any fragmented data received via the antenna 105.

This mode of operation may be standardized or mandated as default, or may be supported by a BA or other negotiation procedure. It also may be accompanied by different variants of BA frames. For example, an HT device may send compressed BA frames when communicating with another HT device, and send uncompressed BA frames when communicating with an older (legacy) device.

In another embodiment, a negotiation or signaling method is used to disable performing fragmentation by the legacy device, such that an HT device will receive non-fragmented data only. In accordance with the present invention, the HT device, (e.g., an AP, a WTRU or the like), sends simple network management protocol (SNMP) messages or commands to the legacy device instructing it to change and/or write new values in its management information base (MIB) parameters related to fragmentation, such as the fragmentation threshold.

In another embodiment, the present invention relies on MAC layer management action frame commands that translate or mimic the SNMP commands but are instead exchanged at the MAC layer, (e.g., as contemplated by IEEE 802.11v standards proposals). Such commands or messages may change the value of the fragmentation threshold to a sufficiently high value that will effectively disable fragmentation, and hence relieve HT devices from having to receive fragments.

In another embodiment, since some legacy stations may not be supporting SNMP or IEEE 802.11v in order to disable them from performing fragmentation, a high-level information message, (e.g., an application, a message, or an email, etc.), is sent to the user of such legacy WLAN device in order to instruct or guide on how to change the fragmentation settings, (e.g., to disallow fragmentation in order to improve the performance), or alternatively send a software application that can run on the device and automatically change the fragmentation settings.

In another embodiment of the present invention, full fragmentation support may be provided by an HT device without significantly increasing the memory requirements that the BA Request (BAR) recipient is required to maintain. In order to achieve full fragmentation, MPDUs or A-MPDUs that contain fragments may immediately solicit an ACK or a BA, by utilizing a normal ACK policy, or an immediate BA policy using an implicit BAR, or using an explicit BAR that immediately follows the fragmented MPDUs. This will effectively result in lower memory requirements on the recipient, since it will not have to maintain for a long time the BA state information for many MSDUs that are fragmented, but instead only for a limited number of MSDUs that are fragmented, (e.g., one MSDU), because that state information will be solicited immediately by the originator.

Alternatively, the use of the BA policy is disallowed within the ACK policy field of an MPDU, or an immediate BAR is sent just after the fragmented MPDUs when utilizing the BA policy. Yet another method is to mandate that the originator does not send more than one fragmented MSDU that is outstanding and unacknowledged to a particular recipient. Alternatively, the originator is disallowed from increasing the starting sequence number (SSN) with a new BAR until the current fragmented MSDU is correctly received.

In another embodiment of the present invention, fragmentation by an HT device is not always supported. For example, a mode is provided that supports fragmentation when normal ACK policy is used within the ACK policy field of the MPDU header, but not when BA policy is used.

FIG. 2 is a block diagram of a WTRU 200 configured with a selectable fragmentation capability in accordance with another embodiment of the present invention. The WTRU 200 includes an antenna 205, a data defragmentation unit 210, a receiver 215, a processor 220, a data fragmentation unit 225, a transmitter 230 and a fragmentation selection unit 235. The transmitter 230 of the WTRU 200 transmits data with or without fragmentation, depending upon decisions made by the processor 220. If fragmentation is not desired, the processor controls the fragmentation selection unit 235 via a control path 240 such that the data fragmentation unit 225 is bypassed, (i.e., disabled). The data defragmentation unit 210 defragments any fragmented data received via the antenna 205.

There are two variants of using normal ACK policy, one where there is a BA agreement established for the flow, and the other where there is not. When there is a BA agreement already established, a problem arises as to how to maintain and report the ACK status, (BA bitmap), for a BA flow that makes use of normal ACK policy for transmitting fragments.

The solution according to the present invention may involve standardizing a rule that specifies that the status of fragment 0000 shall be the status stored and reported in the BA packet, whereby the status of all other fragments, (e.g., fragments numbered 0001 to 1111), shall be ignored by the recipient in the BA scheme.

Alternatively, the recipient reports an acknowledgement status of 0, (i.e., unacknowledged), in the BA response for any SN with fragments, (i.e., ignore updating the status for fragments), and rely on the originator to find out the acknowledgement status of such an MSDU by utilizing a normal ACK policy).

In another embodiment, combining fragmentation with A-MPDU aggregation is addressed for when fragmentation is to be supported under normal ACK policy. Whether or not to support A-MPDU aggregation with fragmentation in this context may be viewed as a special case of the following general problem: whether or not to support A-MPDU aggregation and still utilize/solicit a normal ACK instead of a BA.

To resolve this problem, the solicitation of a normal ACK for A-MPDU aggregates is not supported. The solicitation of a normal ACK for A-MPDU aggregates is supported only if there is no BA agreement. A rule is specified that if the flow does not have a BA agreement, then the recipient generates a normal ACK for the A-MPDU when the normal ACK policy is set in all the MPDUs within the A-MPDU. The solicitation of a normal ACK for A-MPDU aggregates are not allowed, (i.e., not supported), only if there is a BA agreement.

The solicitation of a normal ACK for A-MPDU aggregates in both cases is supported, (regardless of whether there is a BA agreement or not). The overloading of the ACK policy field is avoided in order to solicit an implicit BAR. Instead, another bit to signal an implicit BAR is utilized. Thus, the normal ACK policy can be dedicated for soliciting normal ACKs in all cases.

Additionally, the following describes several alternative methods in which the recipient can communicate the acknowledgement to the originator when receiving an A-MPDU aggregate where normal ACK policy has been set in the header of the MPDUs, and where some of the MPDUs contain fragments.

In one embodiment, the recipient generates an uncompressed BA frame that contains the BA status of the fragments, even if there is no BA agreement in place.

In another embodiment, the recipient generates an uncompressed or a compressed BA frame that contains the BA status of the MPDUs within an A-MPDU aggregate, if there is no BA agreement in place.

In yet another embodiment, the recipient generates a normal ACK frame only if all of the MPDUs, (i.e., fragments), within the A-MPDU are received correctly.

A new type of BA frame is introduced, which uses the compressed BA frame format, but has a bit in the frame to signal that this frame's bitmap contains fragment acknowledgement states information instead of MSDU acknowledgement states. For example, such BA frame can contain 64 bits of bitmap, which can provide status information on up to four consecutive MSDUs each containing up to sixteen fragments.

In another embodiment, the MPDU density capability is utilized whereby a minimum separation of MPDUs in an A-MPDU is required and is negotiable (MPDUs density) in order to facilitate the introduction and/or interoperation and/or compatibility of fragmentation with other IEEE 802.11n features. This enhances the MPDU density feature, and makes it feature-dependent. For example, if the station performs fragmentation and A-MPDU aggregation, then it can use a certain value of MPDU density. If it performs fragmentation and encryption and A-MPDU aggregation, it may use another value for MPDU density parameters. Such MPDU density values are preferably negotiated between the stations on a per-feature or per-features combination basis.

In another embodiment of the present invention, the fragment number field may be used for various purposes when fragmentation is disabled, (or not being used), such as utilizing the fragment number field for signaling purposes for example.

The following preferred methods dynamically identify whether the fragment number field is being utilized to carry fragmentation-related information, or alternatively being utilized for other purposes such as signaling.

A first method is to use one bit in the fragment number field or in the MPDU header in general, to explicitly indicate whether the fragment number field is being used to contain other information, such as signaling and control information. If such a bit is located within the fragment number field, it preferably implies that the maximum number of allowed fragments becomes reduced, (e.g., eight instead of sixteen), when the fragmentation feature is used.

Another method is to rely on other fields, such as the ACK policy field of the MPDU header for example, to deduce whether the fragment number field is being utilized to carry other information or not. For example, as some of the methods of this disclosure have suggested, if fragmentation is allowed only under certain situations or scenarios such as having a normal ACK policy, then the recipient can deduce upon receiving an MPDU with a different policy, such as a BA policy, that such an MPDU can be carrying the newly proposed signaling/control information within its fragment number field.

The fragment number field alternatively can contain other types of information such as signaling/control or cyclic redundancy check (CRC) information. It is preferred that such a field is to be used for security and/or encryption and/or integrity protection purposes. Also, such field is preferably used for time-stamping purposes, for example to stamp the time when the frame was transmitted by the originator, or to stamp the time that the frame spent, (i.e., was delayed for), in the originator's MAC, or to stamp the time that is remaining until the expiry of the lifetime parameter of the packet, or to stamp any other time related information. Alternatively, instead of using the fragment number field, another method can be used that utilizes parts of the HT control field or any field within the MPDU header, (or MSDU header or any part of the frame header or frame body in general), for time-stamping purposes. For example, the time may be stamped when the frame was transmitted by the originator, or to indicate the time that the frame spent, (i.e., was delayed for), in the originator's MAC, or to indicate the time that is remaining until the expiration of the lifetime parameter of the packet, or any other time related information. Such time-stamping capability can be useful in resolving how the TSPEC parameters relate to MSDU lifetime.

In the case of quality of service (QoS) flows, what is important is the peer-to-peer transport delay at the top of the MAC. This is composed of buffering delay, channel access delay, transmit duration, reassembly delay and reordering delay. Unfortunately, IEEE 802.11e is not a complete solution as the transmitter can respect the first two by discarding an MSDU that is going to be too late. However, the receiver does not know the delay introduced by the transmitter, and so can only discard an MSDU at the receiver when it has independently exceeded its transport delay limit. So the actual max limit is twice that of the declared limit. In order to resolve this, it is preferred by the present invention to include a timestamp within the transmitted frame which can be used by the recipient to deduce the remaining lifetime of the MSDU, and which can enable the receiver to measure and/or decide on whether or not to discard the MSDU, and hence resolve the previous issue.

Another embodiment of the present invention relates to how the fragment number field is treated by the encryption algorithms of IEEE 802.11i. Currently, according to IEEE 802.11i, the fragment number field is not masked out, (i.e., it is not set to zeroes before encryption). Even though this could be acceptable and the fragment number field can still be used for many types of signaling, a preferred improvement by the present invention masks out the fragment number field, (i.e., set to 0000 before encryption), or makes it not encrypted in any way.

Another embodiment of the present invention is related to supporting A-MSDU aggregation with fragmentation. A-MSDU refers to an MPDU that encapsulates two or more MSDUs to be transmitted to the same receiver address (RA). Since the A-MSDU aggregation is indicated by the reserved bit 7 of the QoS Control field of the MPDU, it is preferred by the present invention that all fragments, (i.e., all MPDUs that contain the fragments of an A-MSDU), indicate A-MSDU aggregation in each of them, in order to facilitate the A-MSDU de-aggregation implementation at the recipient.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for in use in a wireless transmit receive unit (WTRU), user equipment, terminal, base station, radio network controller, or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A wireless transmit/receive unit (WTRU) comprising:
(a) an antenna;
(b) a data defragmentation unit in communication with the antenna;
(c) a receiver in communication with the data defragmentation unit;
(d) a processor in communication with the receiver and the data defragmentation unit; and
(e) a transmitter in communication with the processor and the antenna, wherein the data defragmentation unit defragments any fragmented data received via the antenna, and the transmitter transmits data via the antenna without fragmenting the data.

2. The WTRU of claim 1 wherein the data defragmentation unit, the receiver, the processor and the transmitter are incorporated in an integrated circuit (IC).

3. In a wireless local area network (WLAN) which supports communications among a plurality of wireless transmit/receive units (WTRUs) via aggregated packet data units, a method comprising:
disallowing at least one of the WTRUs from transmitting fragmented data packet units; and
allowing each of the WTRUs to defragment received data packet units that are fragmented.

4. The method of claim 3 wherein the aggregated packet data units are aggregated medium access control (MAC) service data units (A-MSDUs).

5. The method of claim 3 wherein the aggregated packet data units are aggregated medium access control (MAC) protocol data units (A-MPDUs).

6. The method of claim 3 further comprising:
at least one of the WTRUs sending compressed block acknowledgment (BA) frames when communicating with a high throughput (HT) device; and
the at least one WTRU sending uncompressed BA frames when communicating with a non-HT device.

7. The method of claim 3 wherein compressed block acknowledgement (BA) frames are utilized in a WTRU when fragmentation is not used.

8. The method of claim 3 wherein uncompressed block acknowledgement (BA) frames are utilized in a WTRU when fragmentation is used.

9. The method of claim 6 further comprising:
using a negotiation process to disable performing fragmentation by a non-HT device so that an HT device only receives non-fragmented data.

10. The method of claim 7 wherein the HT device sends simple network management protocol (SNMP) commands to the non-HT device instructing it to change management information base (MIB) parameters related to fragmentation.

11. The method of claim 7 further comprising:
sending a high-level information message to a user of a non-HT device, the message instructing the user on making changes to fragmentation settings.

12. The method of claim 7 further comprising:
sending a software application that can run on the non-HT device in order to automatically change fragmentation settings.

13. The method of claim 12 wherein the high-level information message includes one of an application, a message and an email.

14. A method of processing data comprising:
(a) determining whether or not received data is fragmented data;
(b) generating an uncompressed block acknowledgement (BA) response frame when it is determined in step (a) that received data is fragmented data; and
(c) generating a compressed BA response frame when it is determined in step (a) that received data is not fragmented data.

15. The method of claim 14 wherein the uncompressed BA response frame contains the BA status of data fragments.

16. The method of claim 14 wherein the uncompressed BA response frame is transmitted in response to a BA request frame.

17. The method of claim 14 wherein the compressed BA response frame is transmitted in response to a BA request frame.

18. A method of processing data comprising indicating in a control field each of a plurality of fragments of an aggregated medium access control (MAC) service data unit (A-MSDU) that identify the fragments as belonging to the A-MSDU in order to facilitate A-MSDU deaggregation implementation at a recipient.

19. The method of claim 18 wherein the control field is a quality of service (QoS) control field.

20. A wireless transmit/receive unit (WTRU) comprising:
(a) a processor;
(b) a data fragmentation unit;
(c) a transmitter; and
(d) a fragmentation selection unit in communication with the processor, the data fragmentation unit and the transmitter, wherein the processor determines whether or not the transmitter should transmit fragmented data, and when fragmentation is desired as determined by the processor, the processor controls the fragmentation selection unit such that the data fragmentation unit fragments data provided by the processor for transmission by the transmitter.

21. The WTRU of claim 20 wherein the processor, the data fragmentation unit, the transmitter and the fragmentation selection unit are incorporated in an integrated circuit (IC).

22. The WTRU of claim 20 wherein the transmitter sends a block acknowledgment (BA) request to solicit an uncompressed BA response frame when the processor controls the fragmentation selection unit such that the data fragmentation unit fragments data provided by the processor for transmission by the transmitter.

23. The WTRU of claim 20 further comprising:
(e) an antenna in communication with the transmitter;
(f) a data defragmentation unit in communication with the antenna; and
(g) a receiver in communication with the data defragmentation unit and the processor.

24. The WTRU of claim 23 wherein the WTRU sends an uncompressed block acknowledgment (BA) response frame when the receiver receives an aggregated packet data unit (A-MPDU) that contains fragmented data.

25. The WTRU of claim 23 wherein the WTRU sends a normal acknowledgement (ACK) when the receiver receives an aggregated packet data unit (A-MPDU) that contains fragmented data and when all fragmented data within the A-MPDU are received correctly.
